(19) United States
(12) Patent Application Publication
(10) Pub. No.: US 2007/0223139 A1
(43) Pub. Date: Sep. 27, 2007

(54) Method of producing magnetic head and magnetic head

(75) Inventors: Masanori Tachibana, Kawasaki (JP); Hiroto Takeshita, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 11/509,194

(22) Filed: Aug. 23, 2006

(30) Foreign Application Priority Data
Mar. 23, 2006 (JP) 2006-81159

(51) Int. Cl. G11B 5/147; G11B 5/127

(52) U.S. Cl. 360/126; 29/603.1

(57) ABSTRACT

The method of the present invention is capable of highly precisely producing a magnetic head. The method comprises the steps of: forming a pole end part of a magnetic layer, which becomes a magnetic pole and which is formed on a surface of a work piece on which the magnetic head will be formed, into a prescribed shape; coating at least a top part of the magnetic layer with a stopper layer; coating a surface of the work piece, on which the stopper layer has been formed, with an insulating layer, whose polishing rate is higher than that of the stopper layer; polishing the surface of the work piece until the stopper layer, which coats the top part of the magnetic layer, is exposed from the insulating layer; and removing the stopper layer, which has been exposed in a surface of the magnetic layer.

### BACKGROUND OF THE INVENTION

The present invention relates to a method of producing a magnetic head and a magnetic head, more precisely relates to a method of producing a magnetic head, which is preferably applied to form a high-precision magnetic head, such as a main magnetic pole of a vertical magnetic head, and a magnetic head produced by said method.

A typical vertical magnetic head of a magnetic disk drive unit is shown in FIG. 4. The vertical magnetic head comprises: a read-head 8, in which an MR element 6 is sandwiched between a lower shielding layer 5 and an upper shielding layer 7; a write-head 10, in which a write-gap 13 is formed between a main magnetic pole 12 and a return yoke 14; and a recording coil 15.

The vertical magnetic head having the main magnetic pole 12 has a problem of side track erasure, which is caused by a shape of a pole end part of the main magnetic pole 12.

The side track erasure will be explained. When an arm holding the magnetic head is located in an inner part of a recording medium and when the arm is located in an outer part thereof, skew angles are different; therefore, the pole end part of the main magnetic pole passes a part of an adjacent track, so that data recorded in the adjacent track are deleted, and S/N ratio of magnetic recording is made worse. Thus, in a conventional magnetic head, a shape of the pole end part is formed into an inverted trapezoid so as not to badly influence the adjacent track (see Japanese Patent Gazette No. 2005-108348).

A conventional method of forming the pole end part of the main magnetic pole into the inverted trapezoid, so as to prevent the side track erasure, is shown in FIGS. 5A-5F. In FIG. 5A, a seed layer 22 for plating is formed on a surface of a base layer 20; a resist pattern 24 having a concave section, whose sectional shape is an inverted trapezoid, is formed on a surface of the seed layer 22; and a magnetic layer 26 is formed in the concave section by electrolytic plating, in which the seed layer 22 is used as an electric power feeding layer. The magnetic layer 26 is made of, for example, a soft magnetic material, e.g., NiFe.

Next, the resist pattern 24 is removed, then the magnetic layer 26 and a periphery thereof are coated with resist 28 for protection (see FIG. 5B); and useless parts of the seed layer 22 are removed by ion milling (see FIG. 5C).

On the other hand, in FIG. 5D, the pole end part of is formed into an inverted trapezoid without employing the plating process. Namely, the magnetic layer 26 and a barrier layer 29, which is made of a nonmagnetic material, are formed on the base layer 20 by, for example, sputtering, then the pole end part is formed into the inverted trapezoid by a proper manner, e.g., focused ion beam etching (FIB), ion milling, plasma etching with a reaction gas.

In FIG. 5E, a surface of the magnetic layer 26 is coated with an insulating layer 40, which is made of, for example, alumina, so as to make the magnetic layer 26 have a prescribed thickness. In FIG. 5F, a surface of the work piece is polished, by chemical-mechanical polishing (CMP), to make flat, finally the main magnetic pole 26a is formed into a prescribed shape. By the polishing step, the main magnetic pole 26a is exposed.

As shown in FIG. 5E, the surface of the work piece is coated with the insulating layer 40, e.g., alumina layer, because the shape of the pole end part of the main magnetic pole 26a highly influences recording accuracy of the vertical magnetic head. With increasing recording density of a recording medium, accuracy of writing data in the recording medium directly depends on a length and a core width of the main magnetic pole 26a. Therefore, the main magnetic pole 26a of the vertical magnetic head is produced by the steps of: polishing the alumina layer 40 overcoating the main magnetic pole 26a so as to expose the main magnetic pole 26a; and highly precisely polishing the main magnetic pole 26a to have a thickness of about 200 nm.

FIGS. 5E and 5F show the steps of polishing the insulating layer 40 so as to form the main magnetic pole 26a into the inverted trapezoid. By forming the insulating layer 40, the insulating layer 40 of a part corresponding to the main magnetic pole 26a projects upward, so the projection of the insulating layer 40 is polished, little by little, by stages, until reaching the prescribed thickness with monitoring the thickness of the magnetic layer 26. Therefore, it is difficult and troublesome to perform the polishing steps to form the magnetic layer 26 having the prescribed thickness and core-width. Actually, amount of polishing the work piece is great with respect to required accuracy, so the amount of polishing the surface of the work piece (wafer) is partially varied, and some main magnetic poles 26a will be overpolished by the variation.

### SUMMARY OF THE INVENTION

The present invention was conceived to solve the above described problems.

An object of the present invention is to provide a method of producing a magnetic head, in which a magnetic pole, e.g., a main magnetic head of a vertical magnetic head, can be highly precisely produced.

Another object is to provide a highly reliable magnetic head.

To achieve the objects, the present invention has following constitutions.

Namely, the method of producing a magnetic head of the present invention comprises the steps of: forming a pole end part of a magnetic layer, which becomes a magnetic pole and which is formed on a surface of a work piece on which the magnetic head will be formed, into a prescribed shape; coating at least a top part of the magnetic layer with a stopper layer; coating a surface of the work piece, on which the stopper layer has been formed, with an insulating layer, whose polishing rate is higher than that of the stopper layer; polishing the surface of the work piece until the stopper layer, which coats the top part of the magnetic layer, is exposed from the insulating layer; and removing the stopper layer, which has been exposed in a surface of the magnetic layer.

The method may further comprise the step of final-polishing the surface of the work piece after the removing step. With this method, a thickness of the magnetic pole can be precisely controlled.

In the method, the magnetic layer may be formed by the steps of: forming a seed layer for plating on the surface of the work piece; forming a resist pattern having a concave section, whose shape is corresponded to a shape of the magnetic pole and in which the seed layer is exposed as an inner bottom face, on a surface of the seed layer; and performing electrolytic plating, in which the seed layer is used as an electric power feeding layer, so as to form the magnetic layer in the concave section. With this method, the magnetic pole of the magnetic head can be formed by plating.

In the method, the magnetic pole may be formed by the steps of: forming the magnetic layer and the stopper layer; and etching the magnetic layer and the stopper layer so as to form the magnetic pole. With this method, the magnetic layer of the magnetic head can be formed by a film forming process, e.g., sputtering.

In the method, the stopper layer may be made of tantalum, and the insulating layer may be made of alumina.

Next, the magnetic head of the present invention comprises a write-head, which includes a magnetic pole constituted by a plated magnetic layer, the magnetic layer formed on a seed layer for plating, both side faces of a pole end part of the magnetic pole are coated with a nonmagnetic material, and a surface of the magnetic pole in a thickness direction is formed in an exposed face of the magnetic layer.

In the magnetic head, a periphery of the magnetic pole may be filled with an insulating layer, and the surface of the magnetic pole in the thickness direction and a surface of the insulating layer may be on the same level.

In the magnetic head, the nonmagnetic material may be tantalum, and the insulating layer may be made of alumina.

In the method of the present invention, the magnetic layer is coated with the stopper layer and the surface of the work piece is coated with the insulating layer, then the surface of the work piece is polished, so the magnetic layer is protected by the stopper layer while polishing the insulating layer, abrasion of the magnetic layer can be prevented while the polishing step, and variation of the thickness of the magnetic pole, which is caused by polishing the magnetic layer, can be prevented. Further, in the magnetic head of the present invention, the magnetic pole is coated with the nonmagnetic material, so that the highly reliable magnetic head can be provided without spoiling magnetic characteristics of the magnetic pole.

### BRIEF DESCRIPTION OF THE DRAWINGS

Embodiments of the present invention will now be described by way of examples and with reference to the accompanying drawings, in which:

FIGS. 1A-1E are explanation views showing steps of producing a main magnetic pole of a first embodiment;

FIGS. 2A-2F are explanation views showing further steps of producing the main magnetic pole of the first embodiment;

FIGS. 3A-3F are explanation views showing steps of producing a main magnetic pole of a second embodiment;

FIG. 4 is a sectional view of the typical vertical magnetic head; and

FIGS. 5A-5F are explanation views showing the conventional method of producing the main magnetic pole.

### DETAILED DESCRIPTION OF THE EMBODIMENTS

Preferred embodiments of the present invention will now be described in detail with reference to the accompanying drawings.

### First Embodiment

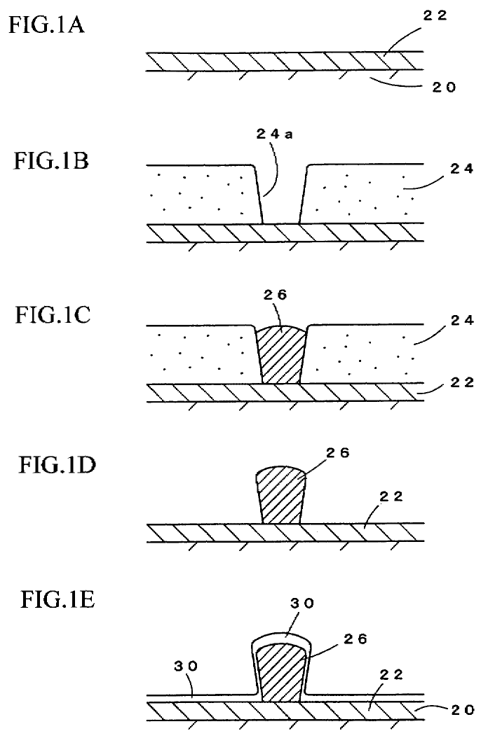

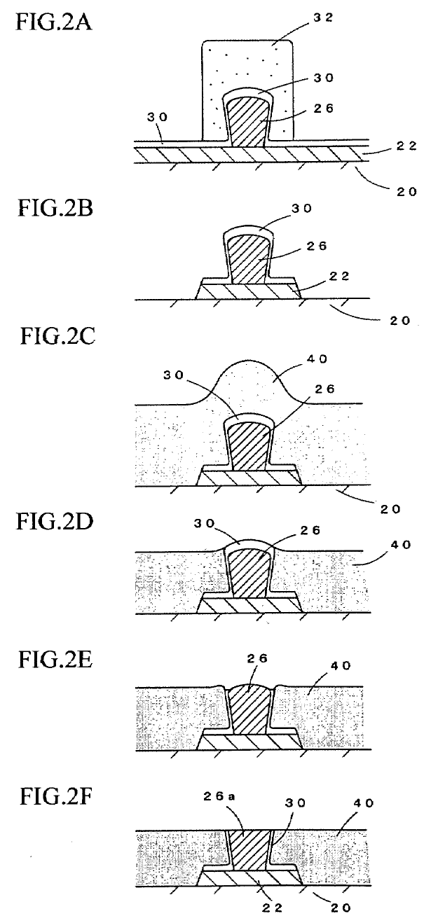

A first embodiment of the method of producing a magnetic head will be explained with reference to FIGS. 1A-1E and 2A-2F. Note that, the magnetic head of the present invention is a vertical magnetic head.

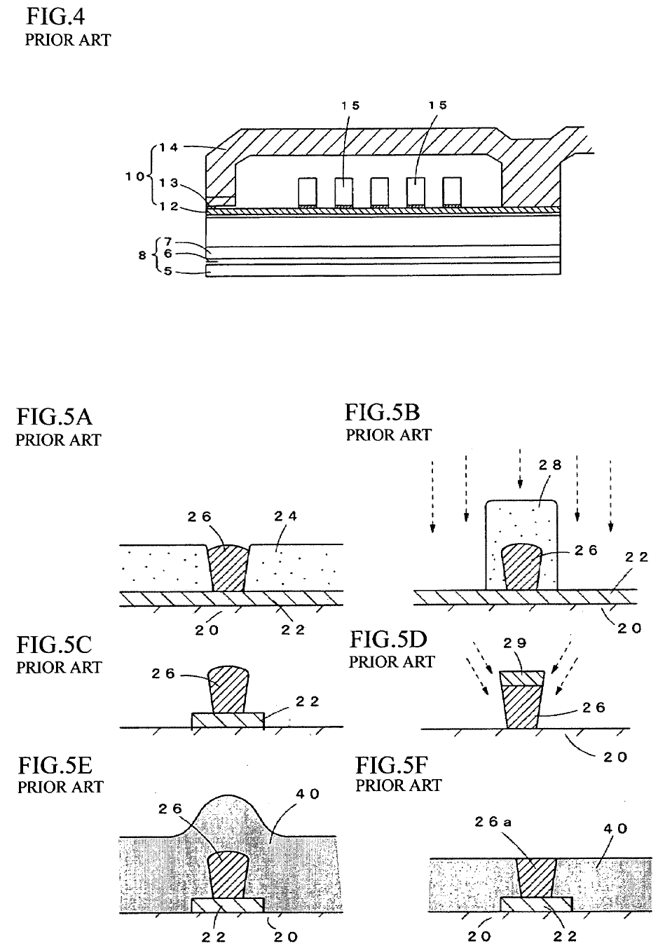

The vertical magnetic head of the present embodiment includes the read-head 8 and the write-head 10, and the lower shielding layer 5, the MR element 6 and the upper shielding layer 7 of the read-head 8 are formed on a substrate by plating or sputtering, as well as the typical vertical magnetic head shown in FIG. 4. The main magnetic pole 12 and the return yoke 14 of the write-head 10, the coil 15, etc. are formed into prescribed patterns by plating or sputtering.

Next, a process of forming the main magnetic pole 12, which is the unique feature of the present invention, will be explained.

FIGS. 1A-1E show the steps until forming a magnetic layer 26, which becomes the main magnetic pole.

In FIG. 1A, a seed layer 22, which is made of, for example, ruthenium, is formed on a surface of a base layer 20, which is formed on a surface of a work piece, by sputtering.

In FIG. 1B, a resist pattern 24 is formed on a surface of the seed layer 22. The resist pattern is patterned, by a photolithographic method, so as to form a concave section 24a, whose shape is corresponded to a planar pattern of a main magnetic pole 26a. In FIG. 1B, a part which becomes a pole end part of the main magnetic pole 26a is seen from an end face side. To form the end face of the main magnetic pole 26a into an inverted trapezoid, a distance between inner side faces of the concave section 24a is gradually increased toward an upper thereof.

In FIG. 1C, the magnetic layer 26 is formed in the concave section 24a of the resist pattern 24 by electrolytic plating, in which the seed layer 22 is used as an electric power feeding layer. The main magnetic pole 26a is made of a magnetic material having high saturation magnetic flux density so as to have excellent soft magnetic characteristics and perform high density recording. For example, the magnetic material having excellent soft magnetic characteristics is NiFe, and the magnetic material having high saturation magnetic flux density is FeCo.

In FIG. 1D, the resist pattern 24 is removed.

In FIG. 1E, a tantalum (Ta) layer is formed on the work piece by sputtering, an upper face and side faces of the magnetic layer 26 and a surface of the seed layer 22 are coated with a stopper layer 30. A thickness of the stopper layer 30 is, for example, about 50 nm.

FIGS. 2A-2F show the polishing steps for shaping the main magnetic pole 26a, whose end face has the prescribed shape.

In FIG. 2A, the surface of the work piece is coated with resist 32, and the resist 32 is patterned, by a photolithographic method, so as to coat the magnetic layer 26 and its periphery.

In FIG. 2B, ion milling is performed in the state, wherein the magnetic layer 26 is coated with the resist 32, and useless parts of the seed layer 22 and the stopper layer 30 are removed.

In FIG. 2C, the surface of the work piece is coated with an insulating layer 40, which is made of an electrically insulating material. The insulating layer 40 is formed by, for example, sputtering alumina. In the surface of the work piece, the magnetic layer 26 has projected from the base layer 20, so a part of the surface corresponding to the magnetic layer 26 is upwardly projected as shown in FIG. 2C by coating the surface of the work piece with the insulating layer 40.

After forming the insulating layer 40, the surface of the work piece is polished by CMP. In the CMP step, the part projected from the insulating layer 40 is removed, and the insulating layer 40 is polished until thickness of the insulating layer 40 reaches that of the magnetic layer 26.

In FIG. 2D, the projected part of the insulating layer 40 is polished until the stopper layer 30 is exposed, and the surfaces of the insulating layer 40 and the stopper layer 30 are made nearly flat.

After forming the insulating layer 40, the polish is started. Firstly, the projected part of the insulating layer 40, which corresponds to the magnetic layer 26, is polished. By advancing the polish, the surface of the insulating layer 40 comes close to a top part of the magnetic layer 26. In the conventional method, by further advancing the polish, the magnetic layer 26 is polished from the top part. On the other hand, in the present embodiment, the magnetic layer 26 is coated with the stopper layer 30; even if the insulating layer 26 is polished and the stopper layer 30 is exposed, the magnetic layer 26 can be protected because polishing rate of the stopper layer 30 is lower than that of the insulating layer 40.

When the stopper layer 30, which coats the top part of the magnetic layer 26, is exposed from the surface of the insulating layer 40, the surfaces of the insulating layer 40 and the stopper layer 30 are made nearly flat and the entire surface of the work piece is made nearly flat as shown in FIG. 2D, the polish is once stopped and the stopper layer 30 coating the top part of the magnetic layer 26 is removed.

In FIG. 2E, a part of the stopper layer 30, which coats the top part of the magnetic layer 26, is removed by etching. The stopper layer 30 is removed by, for example, plasma etching with a reaction gas.

By removing the stopper layer 30 from the top part of the magnetic layer 26, the top part of the magnetic layer 26 is exposed. Therefore, the magnetic layer 26 is left in the original form.

Successively, the surface of the work piece is final-polished by CMP until the thickness of the magnetic layer 26 reaches a prescribed thickness. The final-polish is performed with monitoring the thickness of the magnetic layer 26 and controlling amount of polishing the same.

In FIG. 2F, the magnetic layer 26 has been final-polished until reaching the prescribed thickness. The top part of the magnetic layer 26 is final-polished, and a surface of the top part and the surface of the insulating layer 40 are on the same level.

The main magnetic pole 26a having the prescribed film thickness and the core-width is formed by the above described steps. Side faces of the main magnetic pole 26a are coated with the stopper layer 30, which is made of the nonmagnetic material, and spaces on the both sides of the main magnetic pole 26a are filled with the insulating layer 40, e.g., alumina.

Note that, in the step shown in FIG. 2D, the thickness of the insulating layer 40 is nearly equal to that of the main magnetic pole 26a, so the upper face of the main magnetic pole 26a is made nearly flat when the magnetic layer 26 is formed by plating. If the magnetic layer 26 can be formed with the prescribed thickness, the final-polishing step, which is performed after removing the stopper layer 30 from the top part of the magnetic layer 26, may be omitted.

In the present embodiment, the surface of the magnetic layer 26 is coated with the stopper layer 30, so that polishing the magnetic layer 26 can be prevented when the insulating layer 40, e.g., alumina layer, coating the surface of the work piece is polished. Further, the primary polish, in which the insulating layer 40 is polished until its thickness is made nearly equal to the thickness of the magnetic layer 26, can be performed without polishing the magnetic layer 26. By preventing the magnetic layer 26 from polishing while the surface of the insulating layer 40 is polished so as to flatten its surface, the polishing work can be easily and efficiently performed, and variation of amount of polish occurred in the entire surface of the work piece can be restrained.

In case that the final-polish is performed after the stopper layer 30 coating the top par of the magnetic layer 26 is removed, the surfaces of the insulating layer 40 and the magnetic layer 26 are polished from the state, in which the both surfaces are made nearly flat, until reaching the prescribed film thickness, so amount of the final-polish is very small. Further, the entire surface of the work piece is final-polished from the state, in which the entire surface is nearly flat, until reaching the prescribed final thickness, so the work piece can be highly precisely polished. By improving accuracy of the shape of the main magnetic pole 26a, the highly reliable vertical magnetic head can be produced.

### Second Embodiment

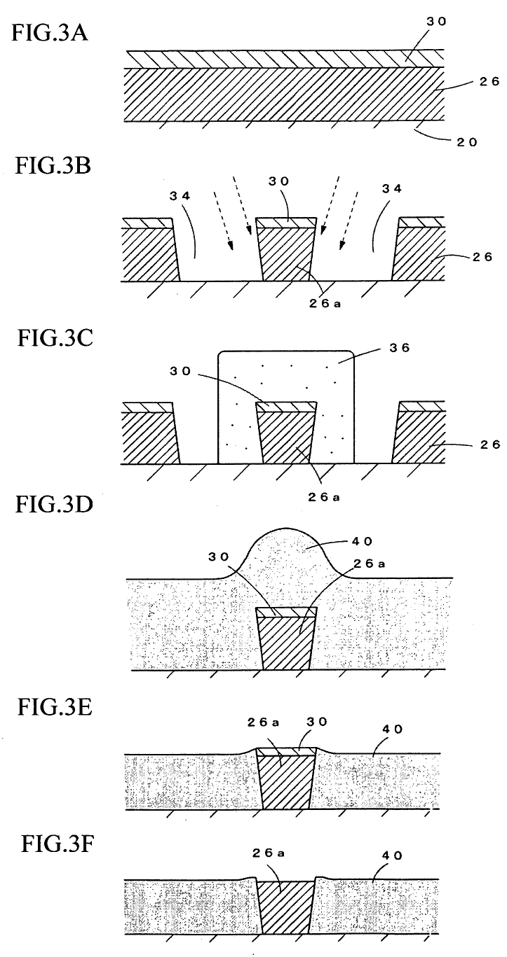

A second embodiment of the method of producing a magnetic head will be explained with reference to FIGS. 3A-3F. Note that, the magnetic head of the present invention is a vertical magnetic head as well as the first embodiment. In the present embodiment, the magnetic layer 26 is formed by a dry process, e.g., sputtering, and the magnetic pole is formed by an FIB process. The structural elements explained in the first embodiment are assigned the same symbols.

In FIG. 3A, the magnetic layer 26 is formed on the surface of the base layer 20 by sputtering, and the stopper layer 30 is formed on the surface of the magnetic layer 26. Thickness of the magnetic layer 26 is previously corresponded to that of the main magnetic pole 26a. The stopper layer 30 is made of a material having low polishing rate, e.g., tantalum, as well as the first embodiment. The stopper layer 30 acts as a barrier layer when the magnetic layer 26 is etched by FIB. Therefore, the stopper layer 30 has enough thickness, e.g., 200 nm, so as to have enough barrier power.

In FIG. 3B, the magnetic layer 26 and the stopper layer 30 are FIB-etched to form the shape of the end face of the main magnetic pole 26a into an inverted trapezoid. By obliquely irradiating focused ion beams toward the surface of the work piece, the end face of the main magnetic pole 26a can be formed into the inverted trapezoid. As shown in FIG. 3B, by irradiating the focused ion beams toward the stopper layer 30 and the magnetic layer 26, opening sections 34 are formed on the both sides of the main magnetic pole 26a.

In FIG. 3C, to remove useless parts of the magnetic layer 26, the surface of the work piece is coated with resist 36, and the resist 36 is patterned to coat protective parts of the magnetic layer 26. An upper face and side faces of the main magnetic pole 26a are coated with the resist 36.

The protective parts of the magnetic layer 26 are coated with the resist 36, and the useless parts of the magnetic layer 26 are removed by ion milling. Further, the resist 36 is removed. Therefore, the magnetic layer 26 located on the both sides are removed.

In FIG. 3D, the surface of the work piece is coated with the insulating layer 40. The insulating layer 40 is formed by sputtering an electrically insulating material, e.g., alumina. By forming the insulating layer 40 on the surface of the work piece by sputtering, the part corresponding to the main magnetic pole 26a is projected upward.

In FIG. 3E, the surface of the work piece is polished, namely the insulating layer 40 is polished until the stopper layer 30 coating the surface of the main magnetic pole 26a is exposed. By forming the stopper layer 30, the main magnetic pole 26a can be protected from the polish when the insulating layer 40 is polished.

In FIG. 3F, the stopper layer 30 coating the top part of the main magnetic pole 26a is removed by, for example, plasma etching so as to expose the upper face of the main magnetic pole 26a. In the following step, a write-gap made of an insulating material will be formed on the surface of the main magnetic pole 26a.

In a film forming process, the thickness of the magnetic layer 26 can be corresponded to that of the main magnetic pole 26a. Thus, in the present embodiment, the magnetic layer 26 is coated with the stopper layer 30 so as not to polish the main magnetic pole 26a in the polishing step, so that the main magnetic pole 26a, whose thickness is equal to that of the original magnetic layer 26. Since the pole end part of the main magnetic pole 26a has been previously formed into the prescribed inverted trapezoid, the end face of the main magnetic pole 26a can be formed into the prescribed shape by removing the stopper layer 30 coating the magnetic layer 26.

In the present embodiment, the surface of the work piece may be final-polished, if required.

In the first and second embodiments, the stopper layer 30 for protecting the magnetic layer 26 is formed by sputtering tantalum (Ta). The stopper layer 30 protects the magnetic layer 26 (the main magnetic pole 26a) so as not to polish the magnetic layer 26 when the insulating layer 40 coating the surface of the work piece is polished. In the present embodiment too, the polishing rate of the stopper layer 30 is lower than that of insulating layer 40. Note that, the stopper layer 30 may be made of other substances, e.g., Ru, other than Ta. In the first embodiment, the stopper layer 30 is left on the side faces of the main magnetic pole 26a, so the preferable stopper layer 30 is made of a nonmagnetic material so as not to badly influence magnetic characteristics of the main magnetic pole 26a.

In the above described embodiments, the stopper layer 30 is used so as to form the main magnetic pole 26a having the prescribed film thickness when the vertical magnetic head is produced, but the present invention is not limited to the vertical magnetic head. For example, the present invention can be applied to a method of producing a magnetic pole of a write-head of a horizontal magnetic head. Further, the present invention can be applied to a method of highly precisely controlling thickness of, for example, electric conductive sections and electric cables of electronic parts.

The invention may be embodied in other specific forms without departing from the spirit of essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. A method of producing a magnetic head,
comprising the steps of:
forming a pole end part of a magnetic layer, which becomes a magnetic pole and which is formed on a surface of a work piece on which said magnetic head will be formed, into a prescribed shape;
coating at least a top part of said magnetic layer with a stopper layer;
coating a surface of said work piece, on which said stopper layer has been formed, with an insulating layer, whose polishing rate is higher than that of said stopper layer;
polishing the surface of said work piece until said stopper layer, which coats the top part of said magnetic layer, is exposed from said insulating layer; and
removing said stopper layer, which has been exposed in a surface of said magnetic layer.

2. The method according to claim 1,
further comprising the step of final-polishing the surface of said work piece after said removing step.

3. The method according to claim 1,
wherein said magnetic layer is formed by the steps of:
forming a seed layer for plating on the surface of said work piece;
forming a resist pattern having a concave section, whose shape is corresponded to a shape of said magnetic pole and in which said seed layer is exposed as an inner bottom face, on a surface of said seed layer; and
performing electrolytic plating, in which said seed layer is used as an electric power feeding layer, so as to form said magnetic layer in the concave section.

4. The method according to claim 1,
wherein said magnetic pole is formed by the steps of:
forming said magnetic layer and said stopper layer; and
etching said magnetic layer and said stopper layer so as to form said magnetic pole.

5. The method according to claim 1,
wherein said stopper layer is made of tantalum.

6. The method according to claim 5,
wherein said insulating layer is made of alumina.

7. A magnetic head comprising a write-head, which includes a magnetic pole constituted by a plated magnetic layer,
wherein said magnetic layer formed on a seed layer for plating,
both side faces of a pole end part of said magnetic pole are coated with a nonmagnetic material, and
a surface of said magnetic pole in a thickness direction is formed in an exposed face of said magnetic layer.

8. The magnetic head according to claim 7,
wherein a periphery of said magnetic pole is filled with an insulating layer, and
the surface of said magnetic pole in the thickness direction and a surface of said insulating layer are on the same level.

9. The magnetic head according to claim 8,
wherein said nonmagnetic material is tantalum, and
said insulating layer is made of alumina.
